(19) United States
(12) Patent Application Publication
(10) Pub. No.: US 2009/0314113 A1
(43) Pub. Date: Dec. 24, 2009

(54) CLAMP CHANGING APPARATUS

(75) Inventors: Zhi-Wei Wang, Shenzhen City (CN); Ga-Lei Hu, Shenzhen City (CN); Chun-Nan Ou, Tu-Cheng (TW); Jian-Long Xing, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECESION INDUSTRY (ShenZhen) CO., LTD., Shenzhen City (CN); HON HAI PRECISION INDUSTRY CO., LTD., Tu-Cheng (TW)

(21) Appl. No.: 12/241,090

(22) Filed: Sep. 30, 2008

(30) Foreign Application Priority Data
Jun. 18, 2008 (CN) 200810302189.4

(51) Int. Cl. F16B 15/08

(52) U.S. Cl. 74/148

(57) ABSTRACT

A clamp changing apparatus includes a coupling device capable of being secured on a robot arm and a clamp-holding device. The coupling device includes a main body defining a blind hole, a connecting portion defining a through hole communicating with the blind hole, and a piston. The connecting portion has a ring-shaped protrusion aligned with the through hole facing away from the main body. The protrusion defines a plurality of holes running through the lateral wall thereof, each of the holes receives a rigid ball in which the diameter is bigger than the depth of the hole. The piston is received in the blind hole and the through hole, and is slidable along them to push the rigid balls out of the protrusion. The clamp-holding device is capable of being fixed to a clamp and defines a latching hole corresponding to the protrusion.

### BACKGROUND

1. Field of the Invention

The present invention relates to clamp changing apparatuses and, particularly, to a clamp changing apparatus capable of automatically changing a currently-used clamp for a next clamp to be used.

2. Description of the Related Art

Currently, the operation of changing a clamp of a robot or a machine, particularly a complicated or heavy clamp, has to be performed manually by at least two operators using tools such as levers, screw drivers, or other special tools. Detachment of such a clamp and replacement with another clamp also must be done while the machine is stopped, and thus, operation of the machine cannot be continuous during production cycles. Consequently, valuable time and power are wasted, thereby leading to low productivity.

What is needed, therefore, is a clamp changing apparatus to overcome the above-described problem.

### SUMMARY

In an exemplary embodiment, a clamp changing apparatus includes a coupling device capable of being secured on a robot arm, and a clamp-holding device capable of being fixed to a clamp. The coupling device includes a main body defining a blind hole, a connecting portion defining a through hole communicating with the blind hole, and a piston. The connecting portion has a ring-shaped protrusion aligned with the through hole and facing away from the main body. The protrusion defines a plurality of holes running through the lateral wall thereof. Each of the holes receives a rigid ball in which the diameter is bigger than the depth of the hole. The piston is received in the blind hole and the through hole, and is slidable along them to push the rigid balls out of the protrusion. The clamp-holding device defines a latching hole corresponding to the protrusion.

### BRIEF DESCRIPTION OF THE DRAWINGS

Many aspects of the present clamp changing apparatus can be better understood with references to the following drawings. The components in the drawings are not necessarily drawn to scale, the emphasis instead being placed upon clearly illustrating the principles of the present clamp changing apparatus.

FIG. 1 is a schematic view of a clamp changing apparatus, a robot arm, and a clamp according to an exemplary embodiment.

FIG. 2 is a partially exploded view of the clamp changing apparatus of FIG.1.

FIG. 3 is a cross-sectional view of the clamp changing apparatus of FIG. 1 with a coupling portion and a clamp-holding portion separately.

FIGS. 4-6 illuminate the connecting process of the coupling portion and the clamp-holding portion of FIG. 3.

### DETAILED DESCRIPTION OF THE EMBODIMENTS

Embodiments of the present invention will now be described in detail below, with references to the accompanying drawings.

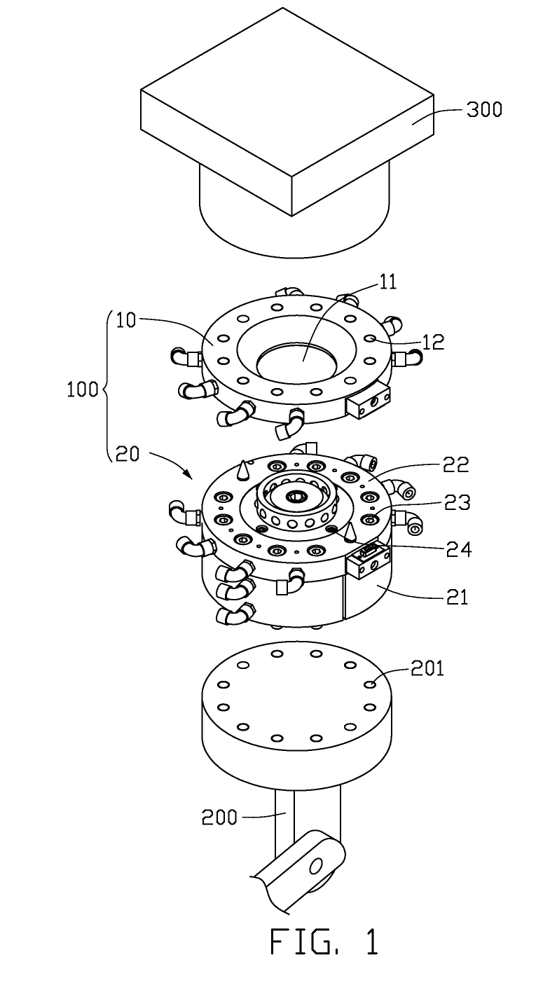

Referring to FIGS. 1 to 3, a clamp changing apparatus 100, according to an exemplary embodiment, is shown. The clamp changing apparatus 100 includes a clamp-holding device 10 and a coupling device 20. The clamp-holding device 10 is fixed to a clamp 300. The coupling device 20 is secured on a robot arm 200.

The coupling device 20 includes a main body 21, a connecting portion 22, and a piston 25.

The main body 21 has a first surface 211 facing away from the connecting portion 22 and an opposite second surface 212 facing the connecting portion 22. In the present embodiment, the main body 21 has two guide pins 213 extending from the second surface 212 along a direction perpendicular to the second surface 212. The main body 21 defines a blind hole 214 at the center of the second surface 212. A first air channel 215 and a second air channel 216 extend from the lateral side of the main body 21 and communicates with the blind hole 214, respectively. The first air channel 215 is located at the bottom of the blind hole 214 and the second air channel 216 is located at the top of the blind hole 214. The main body 21 further defines a number of through holes 231, running through the first surface 211 and the second surface 212, surrounding the blind hole 214 and defining three screw holes 241 on the first surface 211 thereof surrounding the blind hole 214.

The connecting portion 22 has a third surface 221 facing the main body 21 and an opposite fourth surface 222 facing away from the main body 21. The connecting portion 22 defines a through hole 223 at the center of the fourth surface 222 and runs through the third surface 221 and the fourth surface 222, along with two guide holes 225 spatially corresponding to the guide pins 213 of the main body 21. The connecting portion 22 further includes a ring-shaped protrusion 224 extending from the fourth surface 222. The protrusion 224 is aligned with the through hole 223, and the center hole of the protrusion 224 communicates with the through hole 223. The protrusion 224 defines a number of holes 224a running through its lateral wall. Each of the holes 224a receives a moving part such as a rigid ball 224b therein. The diameter of the hole 224a is essentially equal to the diameter of the rigid ball 224b. The depth of the hole 224a is shorter than the diameter of the rigid ball 224b. As a result, the rigid ball 224b always has a portion extending out of the hole 224a. The rigid ball 224b can be made of steel. The connecting portion 22 further defines a number of through holes 232 spatially corresponding to the through holes 231 of the main body 21. A number of first screws 23 are inserted into a number of first screw holes 201 of the robot arm 200 through the through holes 231 of the main body 21 and the through holes 232 of the connecting portion 22 to secure the coupling device 20 onto the robot arm 200. The connecting portion 22 further defines three through holes 242 spatially corresponding to the screw holes 241 of main body 21. Three second screws are inserted into the screw holes 241 through the through holes 242 to secure the connecting portion 22 and the main body 21 together.

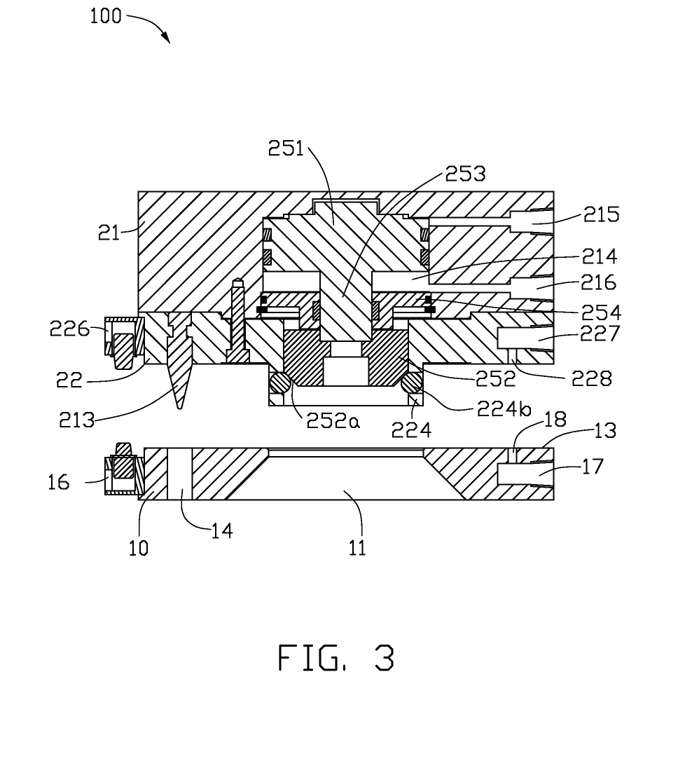

Referring to FIG. 3, the piston 25 includes a head member 251, a cylinder pressing portion 252, a rod 253 connecting with the head member 251 and the cylinder pressing portion 252, and a stopper 254 circling around the rod 253. The head member 251 is received in the blind hole 214 of the main body 21, and is slidable in the blind hole 214 by air pressure of the first air channel 215 and/or the second air channel 216 located at two side of the head member 251. The pressing portion 252 is received in the through hole 223 of the connecting portion 22, and is slidable along the through hole 223 and the center hole of the protrusion 224 when the head member 251 slides into the blind hole 214. The diameter of the pressing portion 252 is essentially equal to the inner diameter of the protrusion 224, therefore, the pressing portion 252 can press the rigid ball 224b to move out of the protrusion 224 when it slides into the protrusion 224. The pressing portion 252 also has a chamfer 252a at an end thereof away from the head member 251, in order to easily press the rigid ball 224b. The stopper 254 is received in the blind hole 214 and has a diameter bigger than the diameter of the through hole 223 of the connecting portion 22 for limiting the sliding distance of the head member 251 in the blind hole 214.

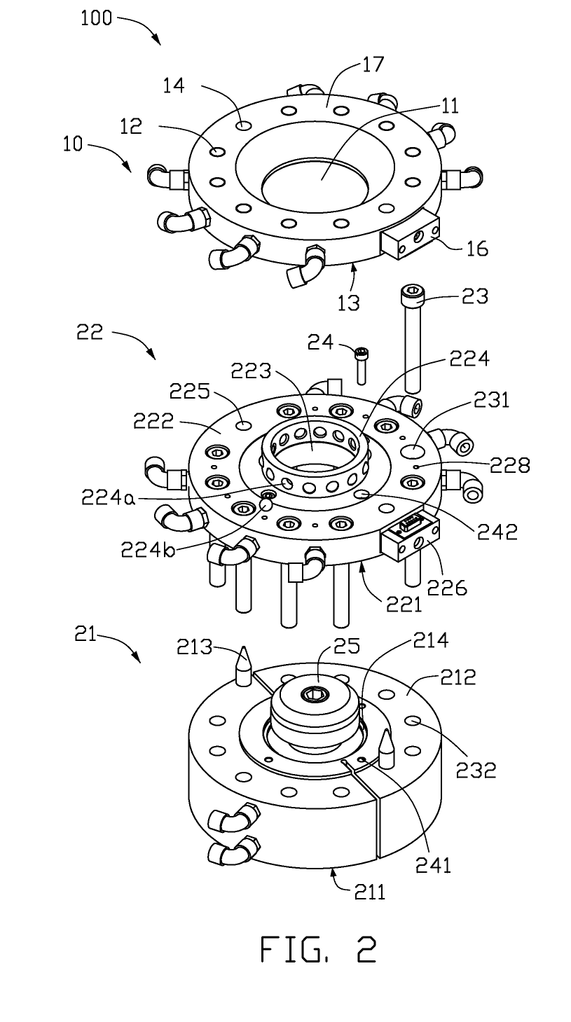

Referring back to FIG. 2, the clamp-holding device 10 has a fifth surface 13 facing away from the clamp 300 and an opposite sixth surface 17 near the clamp 300. A number of screw holes 12 are defined at the sixth surface 17 and are configured for fixing the clamp-holding device 10 to the clamp 300 by screws. The clamp-holding device 10 defines a latching hole 11 at the center thereof and is capable of engaging with the protrusion 224. The diameter of the latching hole 11 at the end thereof near the first surface 13 is essentially equal to the outer diameter of the protrusion 224. The diameter of the latching hole 11 increases gradually along the direction facing away from the first surface 13 so as to form slanted sidewalls surrounding the latching hole 11. The clamp-holding device 10 also defines two guide holes 14 for engaging with the guide pins 213 of the main body 21.

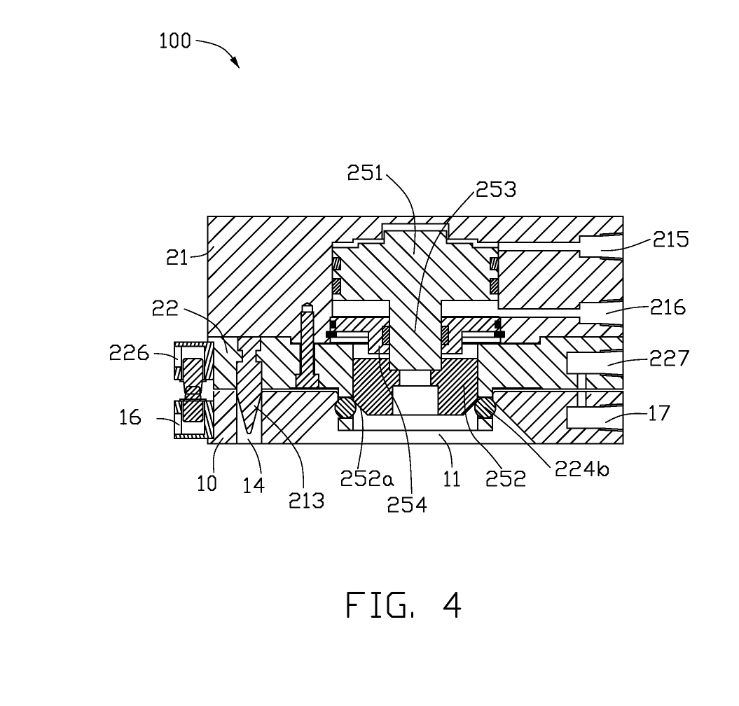

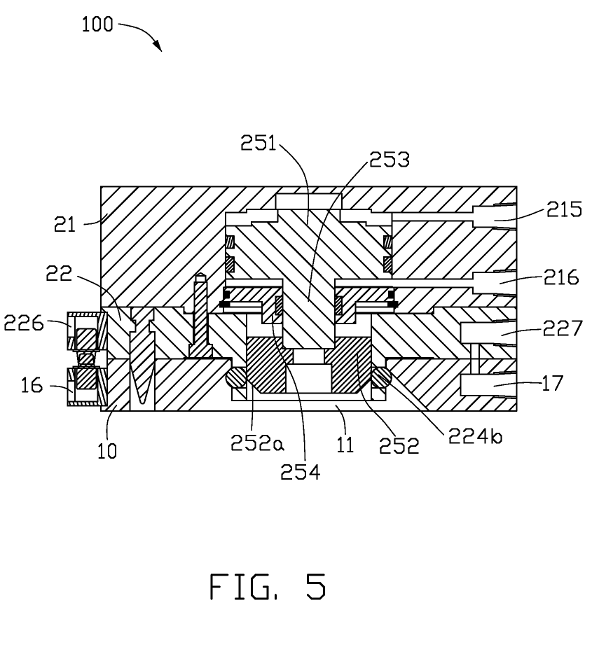

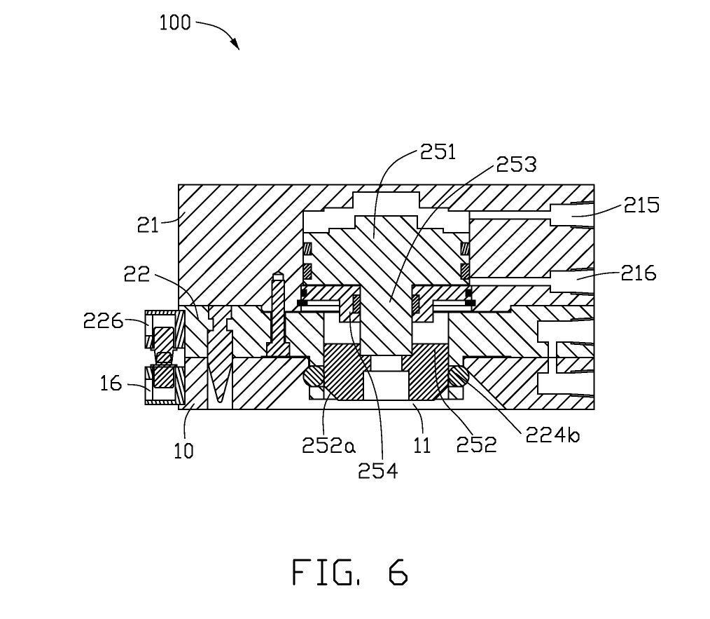

Referring to FIGS. 3-6, if the robot arm 200 with the coupling device 20 secured thereon wants to use the clamp 300 fixed with the clamp-holding device 10, the robot arm 200 will move the coupling device 20 and insert the protrusion 224 into the latching hole 11 of the clamp-holding device 10, subsequently pushing the piston 25 to slide towards the clamp-holding device 10 via air pressure in the first air channel 215. The piston 25 will press the rigid ball 224b to move a portion thereof out of the protrusion 224 and against the slanted sidewalls of the latching hole 11. As a result, the coupling device 20 can be secured with the clamp-holding device 10, and accordingly, the clamp 300 can be picked up by the robot arm 200. On the contrary, if the robot arm 200 wants to put down the clamp 300, the robot arm 200 can push the piston 25 to slide along a direction away from the clamp-holding device 10 via air pressure in the second air channel 216 and then move robot arm 200 away from the clamp 300 to release the clamp 300.

In the present embodiment, the connecting portion 22 also has an electrical connector 226, and the clamp-holding device 10 has an electrical connector 16 corresponding to the connector 226. The electrical connector 226 can be connected to the electrical connector 16 when the protrusion 224 is inserted into the latching hole 11 of the clamp-holding device 10, and sends a signal to the robot corresponding to the robot arm 200. Subsequently, the robot knows the protrusion 224 has been inserted into the latching hole 11 and will increase air pressure in the first air channel 215 to push the piston 25 to slide towards the clamp-holding device 10 and secure the coupling device 20 with the clamp-holding device 10.

In the present embodiment, the connecting portion 22 further defines a number of third air channels 227, each with an opening 228 on the fourth surface 221 thereof, and the clamp-holding device 10 defines a number of fourth air channels 17, each with an opening 18 on the fifth surface 13. The openings 18 are spatially corresponding to the openings 228. The fourth air channels 17 can be connected to the third air channels 227 when the coupling device 20 is secured with the clamp-holding device 10, and therefore, the fourth air channels 17 can be used for providing driving power for the clamp 300.

While certain embodiments have been described and exemplified above, various other embodiments will be apparent to those skilled in the art from the foregoing disclosure. The present invention is not limited to the particular embodiments described and exemplified, and the embodiments are capable of considerable variation and modification without departure from the scope of the appended claims.

What is claimed is:

1. A clamp changing apparatus comprising:
a coupling device capable of being secured on a robot arm, the coupling device comprising:
a main body defining a blind hole;
a connecting portion defining a through hole communicating with the blind hole, the connecting portion having a ring-shaped protrusion aligned with the through hole and facing away from the main body, the protrusion defining a plurality of holes running through the lateral wall thereof, each of the holes receiving a rigid ball in which diameter is bigger than the depth of the hole; and
a piston received in the blind hole and the through hole and slidable therein to push the rigid balls out of the protrusion; and
a clamp-holding device capable of being fixed to a clamp, the clamp-holding device defining a latching hole corresponding to the protrusion.

2. The clamp changing apparatus as claimed in claim 1, wherein the main body further includes a number of guide pins, and both the connecting portion and the clamp-holding device has a number of guide holes corresponding to the guide pins.

3. The clamp changing apparatus as claimed in claim 1, wherein the piston comprising a head member, a cylinder pressing portion, and a rod connecting the head member and the cylinder pressing portion, the head member is received in the blind hole and the cylinder pressing portion is receive in the through hole of the connecting portion.

4. The clamp changing apparatus as claimed in claim 3, wherein the main body defines a first air channel and a second air channel communicating with the blind hole, the first air channel and the second air channel are located at two sides of the head member.

5. The clamp changing apparatus as claimed in claim 3, wherein the pressing portion has a chamfer at an end thereof away from the head member.

6. The clamp changing apparatus as claimed in claim 3, wherein the piston further comprises a stopper circling around the rod.

7. The clamp changing apparatus as claimed in claim 1, wherein the rigid ball is a steel ball.

8. The clamp changing apparatus as claimed in claim 1, wherein the diameter of the latching hole at the end thereof near the connecting portion is essentially equal to the outer diameter of the protrusion, the diameter of the latching hole increases gradually along the direction facing away from the connecting portion.

9. The clamp changing apparatus as claimed in claim 1, wherein the connecting portion further has an electrical connector, and the clamp-holding device has an electrical connector corresponding to the connector.

10. The clamp changing apparatus as claimed in claim 1, wherein the connecting portion further defines a number of third air channels each with an opening on the surface thereof facing away from the main body, and the clamp-holding device defines a number of fourth air channels each with an opening on the surface thereof facing the connecting portion.

11. A coupling device capable of being secured on a robot arm and latching with a clamp-holding device defining a latching hole, the coupling device comprising:
a main body defining a blind hole;
a connecting portion defining a through hole communicating with the blind hole, the connecting portion having a ring-shaped protrusion for latching with the latching hole of the clamp-holding device, the protrusion aligned with the through hole and facing away from the main body, the protrusion defining a plurality of holes extending through the lateral wall thereof, each of the holes receiving a rigid ball in which diameter is bigger than the depth of the hole; and
a piston received in the blind hole and the through hole, and slidable therein to push the rigid balls out of the protrusion.

12. The coupling device as claimed in claim 11, wherein the main body further includes a number of guide pins, and both the connecting portion and the clamp-holding device has a number of guide holes corresponding to the guide pins.

13. The coupling device as claimed in claim 12, wherein the piston comprises a head member, a cylinder pressing portion, and a rod connecting the head member and the cylinder pressing portion, the head member is received in the blind hole and the cylinder pressing portion is receive in the through hole of the connecting portion.

14. The coupling device as claimed in claim 13, wherein the main body defines a first air channel and a second air channel communicating with the blind hole, the first air channel and the second air channel are located at two sides of the head member.

15. The coupling device as claimed in claim 13, wherein the pressing portion has a chamfer at an end thereof away from the head member.

16. The coupling device as claimed in claim 13, wherein the piston further comprises a stopper circling around the rod.

17. The coupling device as claimed in claim 11, wherein the rigid ball is a steel ball.

18. An apparatus for changing tools for one of robots and machines, comprising:
a clamp-holding device capable of fixing one of said tools thereon; and
a coupling device capable of being assembled to said one of robots and machines, and comprising a piston received therein to move along an axial direction thereof, said coupling device further comprising a connecting portion defining a through hole for said piston to move therethrough, said connecting portion comprising at least one moving part partially located in said through hole and movable within said connecting portion along a direction perpendicular to said axial direction, and when said clamp-holding device abuts against said connecting portion and said piston moves along said axial direction toward said clamp-holding device via said though hole, said at least one moving part being urged by said piston to move along said direction perpendicular to said axial direction and engage with said clamp-holding device so as to secure said clamp-holding device onto said coupling device.

19. The apparatus as claimed in claim 18, wherein said connecting portion defines a surface at a side thereof for abuttal of said clamp-holding device against said connecting portion, and a protrusion extends away from said surface for receiving said at least one moving part therein.

20. The apparatus as claimed in claim 19, wherein said clamp-holding device defines a latching hole to receive said protrusion therein when said clamp-holding device abuts against said connecting portion, said piston is able to move through said latching hole to urge movement of said at least one moving part.
